(19) United States
(12) Patent Application Publication
(10) Pub. No.: US 2024/0220801 A1
(43) Pub. Date: Jul. 4, 2024

(54) METHOD FOR DESIGNING LIGHT WEIGHT REDUCED PARAMETER NETWORKS

(71) Applicant: CARNEGIE MELLON UNIVERSITY, Pittsburgh, PA (US)

(72) Inventors: Dipan Pal, Pittsburgh, PA (US); Marios Savvides, Pittsburgh, PA (US); Uzair Ahmed, Pittsburgh, PA (US); Than Hai Phan, Pittsburgh, PA (US)

(21) Appl. No.: 18/272,856

(22) PCT Filed: Jan. 25, 2022
(86) PCT No.: PCT/US2022/013642

§ 371 Date: Jul. 18, 2023

Related U.S. Application Data
(60) Provisional application No. 63/145,675, filed on Feb. 4, 2021.

(51) Int. Cl. G06N 3/082; G06N 3/04

(52) U.S. Cl. CPC G06N 3/082; G06N 3/04

(57) ABSTRACT

Disclosed herein is a method of reducing the complexity of a neural network using PRC-NPTN layers by applying a pruning technique to remove a subset of filters in the network based on the importance of individual filters to the accuracy of the network, which is determined by the frequency with which the response of the filter is activated.

### RELATED APPLICATIONS

This application claims the benefit of U.S. Provisional Patent Application No. 63/145,675, filed Feb. 4, 2021, the contents of which are incorporated herein in its entirety.

### BACKGROUND

A Permanent Random Connectome—Non-Parametric Transformation Network (PRC-NPTN) is an architectural layer for convolutional networks which is capable of learning general invariances from data itself. This layer can learn invariance to non-parametric transformations and incorporates permanent random connectomes. PRC-NPTN networks are initialized with random connections (not just weights) which are a small subset of the connections in a fully connected convolution layer. Importantly, these connections in PRC-NPTNs, once initialized, remain permanent throughout training and testing. Permanent random connectomes make these architectures more plausible than many other mainstream network architectures which require highly-ordered structures. Randomly initialized connections can be used as a simple method to learn invariance from data itself while invoking invariance towards multiple nuisance transformations simultaneously. These randomly initialized permanent connections have positive effects on generalization, outperform much larger ConvNet baselines and Non-Parametric Transformation Networks (NPTN) on benchmarks such as augmented MNIST, ETH-80 and CIFAR10, that enforce learning invariances from the data itself.

FIG. 1 shows the architecture of a single PRC-NPTN layer. The PRC-NPTN layer consists of a set of Nᵢₙ×G filters of size k×k where Nᵢₙ is the number of input channels and G is the number of filters connected to each input channel. More specifically, each of the Nᵢₙ input channels connects to |G| filters. Then, a number of channel max pooling units randomly select a fixed number of activation maps to pool over. This is parameterized by a parameter referred to herein as Channel Max Pool (CMP). Note that this random support selection for pooling is the reason a PRC-NPTN layer contains a permanent random connectome.

These pooling selection supports, once initialized, do not change through training or testing. Once max pooling over CMP activation maps completes, the resultant tensor is average pooled across channels with an average pool size such that the desired number of outputs is obtained. After the CMP units, the output is finally fed through a two layered network with the same number of channels with 1×1 kernels, which are referred to as a pooling network. This small pooling network helps in selecting non-linear combinations of the invariant nodes generated through the CMP operation, thereby enriching feature combinations downstream.

View (a) of FIG. 2 shows homogeneous structured pooling pools across the entire range of transformations of the same kind leading to feature vectors invariant only to that particular transformations. Here, two distinct feature vectors are invariant to transformation T₁ and T₂ independently. View (b) shows heterogeneous random support pooling pools across randomly selected ranges of multiple transformations simultaneously. The pooling supports are defined during initialization and remain fixed during training and testing. This results in a single feature vector that is invariant to multiple transformations simultaneously. Here, each colored box defines the support of the pooling and pools across features only inside the boxed region leading to one single feature. View (c) shows vectorized random support pooling and extends this idea to convolutional networks, where the random support pooling on the feature grid (View (a)) is equivalent to random support pooling of the vectorized grid. Each element of the vector (View (c)) now represents a single channel in a convolutional network and hence random support pooling in PRC-NPTNs occurs across channels.

There are existing methods for generating invariance through pooling. One such method develops a framework in which the transformations are modelled as a group comprised of unitary operators denoted by {g ∈ G}. These operators transform a given filter w through the operation gw, following which the dot-product between these transformed filters and a novel input x is measured through <x, gw>. Any moment such as the mean or max (infinite moment) of the distribution of these dot-products in the set {<x, gw>| g ∈ G} is an invariant. These invariants will exhibit robustness to the transformation in G encoded by the transformed filters in practice. Though this framework does not make any assumptions on the distribution of the dot-products, it imposes the restricting assumption of group symmetry on the transformations. However, in PRC-NPTN layers, invariance can be invoked even when avoiding the assumption that the transformations in need to form a group. The distribution of the dot-product <x, gw> is uniform.

PRC-NPTN layers perform max pooling across channels not space, to invoke invariance. In the framework <x, gw>, w would be one convolution filter with g being the transformed version of it. Note that this modelling is done only to satisfy a theoretical construction, transform filters are not actually transformed in practice. All transformed filters are learned through backpropagation. This framework is already utilized in ConvNets. For instance, ConvNets pool only across translations (convolution operation itself followed by spatial max pooling implies g to be translation).

Consider a grid of features that have been obtained through a dot product <x, gw> (for instance from a convolution activation map, where the grid is simply populated with each k× k×1 filter, not k×k×c) (see View (a) of FIG. 2). Assume that along the two axes of the grid, two different kinds of transformations are acted. T₁ along the horizontal axis and T₂ along the vertical. T₁=g₁(·; θ₁) where g₁ is a transformation parameterized by θ₁ that acts on w and, similarly, T₂=g₂(·; θ₂). Now, pooling homogeneously across one axis invokes invariance only to the corresponding g. Similarly, pooling along T₂ only will result in a feature vector (Feature 2) invariant only to T₂. These representations (Feature 1 and 2) have complimentary invariances and can be used for complimentary tasks (e.g., face recognition (invariant to pose) versus pose estimation (invariant to subject)). This approach has one major limitation that this scales linearly with the number of transformations which is impractical. One therefore would need features that are invariant to multiple transformations simultaneously. A simple yet effective approach is to pool along all axes thereby being invariant to all transformations simultaneously. However, doing so will result in a degenerative feature (that is invariant to everything and discriminative to nothing). Therefore, the key is to limit the range of pooling performed for each transformation.

A solution to the feature problem described above is to limit the range or support of pooling as illustrated in View (b) of FIG. 2. One simple way of selecting such a support for pooling is at random. This selection would happen only once during initialization of the network (or any other model) and remains fixed through training and testing. To increase the selectivity of such features, multiple such pooling units are needed with such a randomly initialized support. These multiple pooling units together form the feature that is invariant to multiple transformations simultaneously, which improves generalization as we find in our experiments. This is referred to as heterogeneous pooling and View (b) of FIG. 2 illustrates this more concretely.

### SUMMARY

Disclosed herein is a method of reducing the complexity of a neural network using PRC-NPTN layers by applying a pruning technique. Pruning is the process of choosing least important nodes in any pre-trained network and then removing those nodes from the network. Over many iterations, this results in a very small network capable of running on an edge device or low compute-resource hardware. This pruning process also requires additional computation and training time, thereby increasing the complexity and resource intensity of the overall process. The approach disclosed herein improves the performance of networks using PRC-NPTN layers by pruning to provide higher performing networks at the low parameter regime. Training and pruning PRC-NPTN networks requires less resources as they are smaller and more lightweight than traditional convolutional networks. This results in higher performance for smaller networks while being more efficient in terms of FLOPs.

### BRIEF DESCRIPTION OF THE DRAWINGS

By way of example, a specific exemplary embodiment of the disclosed system and method will now be described, with reference to the accompanying drawings, in which:

FIG. 1 is a block diagram showing a PRC-NPTN layer.

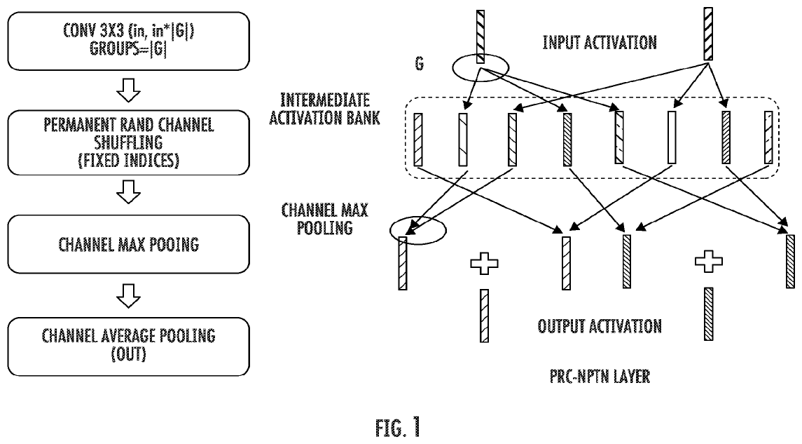

FIG. 2 is a block diagram showing various methods of pooling for networks using PRC-NPTN layers.

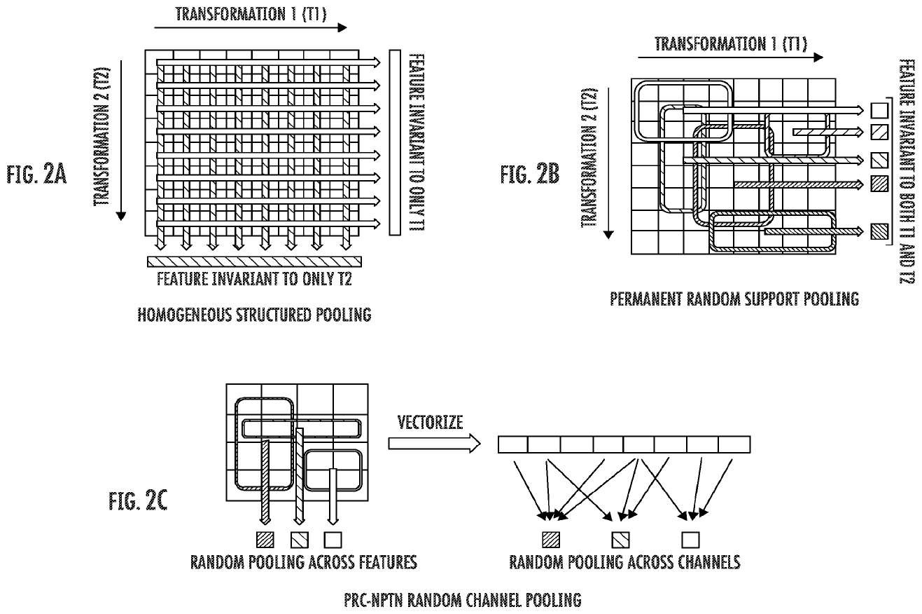

FIG. 3 is a graph showing the results of a benchmarking test with a fixed CMP hyperparameter and a varying G hyperparameter.

FIG. 4 is a graph showing the results of a benchmarking test with a varying CMP hyperparameter and a fixed G hyperparameter.

### DETAILED DESCRIPTION

The details of the invention will now be described. A network having PRC-NPTN benefits from the use of permanent random connectomes in terms of better prediction performance, transformation modelling and computational complexity savings. Networks employing PRC-NPTN layers allow significantly smaller sized networks compared to baselines to offer competing performance.

Pruning is a way to distill a large, trained network down to a smaller size, while keeping most of its prediction performance and accuracy intact. The goal of a pruning process aligns with one of the practical motivations of PRC-NPTN, that is, to provide maximum prediction performance for a given amount of limited computational resources/parameters. Applying pruning techniques to PRC-NPTNs provides a distilled (smaller/lower parameter) network which offers better performance than vanilla ConvNet baselines.

In one embodiment of the invention, L1 pruning is used. In this embodiment, a filter is pruned if the L1 norm of its response (i.e., activation) is in the bottom segment, as defined by a hyperparameter. The hyperparameter is referred to as a pruning factor that can be set between 1 (no pruning) and 0 (complete pruning). For example, a pruning factor of 0.8 means that the top 80% of the filters are kept (i.e., the top segment), while the bottom 20% of filters are removed (i.e., the bottom segment). This effectively only keeps filters that on average provide high enough activation responses. The pruning factor can be understood as the factor or percent of parameters to keep while pruning or permanently deactivating the rest.

Once the network is trained, it is pruned in the trained state using a chosen pruning factor. Once the network is pruned, it is fine-tuned again using the same 300 epoch protocol with a learning rate starting from 0.01 decreased by a factor of 10 at 150 and 250 epochs. In this manner, a curve is formed by training a single model for a given fixed set of parameters, and then pruning the network for different amounts and fine-tuning. This is pruning at a single shot for a single amount and not iteratively as the degree of pruning increases.

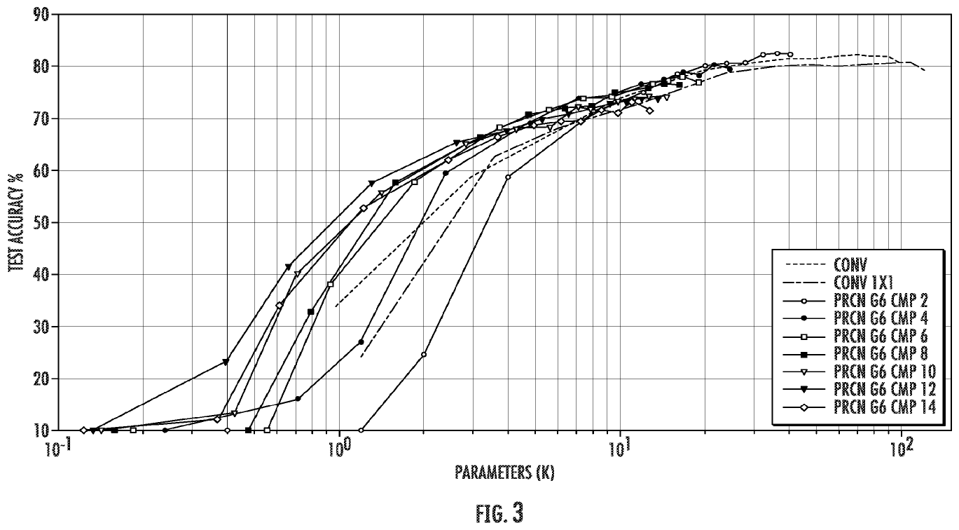

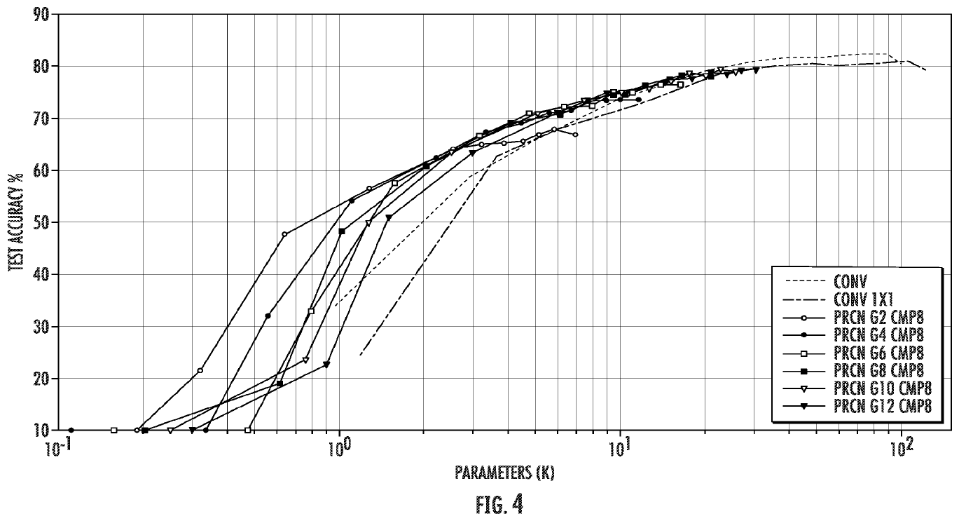

The determine the effects of varying CMP, PRC-NPTNs for G fixed at 6 (with the CMP ranging from 2-12) and CMP fixed at 8 (with G ranging from 2-12) were benchmarked. FIG. 3 and FIG. 4 show the results of the benchmarking.

FIG. 3 shows PRC-NPTN pruning using a fixed value for hyperparameter G while varying CMP. Different models have varying CMP PRC-NPTN along with pruning allows control over focus on performance at lower or higher parameter regimes. Each curve is a separate model trained for a different value of CMP. The PRC-NPTN curve for (G=6, CMP=2) shows better performance at high parameter regime for low CMP. On the other hand, the PRC-NPTN curve for (G=8, CMP=12) shows better performance at low parameter regime using high CMP. FIG. 4 shows using a fixed value for hyperparameter CMP while varying G. The PRC-NPTN curve for (G=2, CMP=8) shows better performance at low parameter regime for low G. On the other hand, the PRC-NPTN curve for (G=12, CMP=8) shows better performance at high parameter regime using high G.

The results show that PRC-NPTNs provide significantly higher test performance for a given parameter budget at the lower parameter settings. In fact, at around 1100 parameters, as shown in FIG. 3, PRC-NPTNs with CMP higher than 2 provide accuracies in the 60% range whereas baseline ConvNet achieved 50% (and, in fact, the deeper ConvNet 1×1 baseline achieved only 30% accuracy). Furthermore, for lower CMP values (i.e., CMP=2), PRC-NPTN outperforms both baselines with an accuracy of 82.44% using 40.4K parameters versus the highest achieved by ConvNet baseline of 82.33% using 68.9K parameters. Hence, PRC-NPTNs provide this additional tuning parameter called CMP or channel max pooling, the use of which provides higher performance with lower and higher parameter settings. A similar trend is found in FIG. 4 with much higher performance at even lower ranges. However, performance peaks out in the higher parameter regime with larger G. Overall, this provides a new and effective dimension along with one can decide how best to utilize the resources utilized by the network. Such a dimension simply does not exist with baseline architectures which do not have the PRC-NPTN structure.

Based on the results shown in FIG. 3 and FIG. 4, in one embodiment, a potential method of choosing the hyperparameters G and CMP is to have them depend on the compute resources of the application at hand. If the application is able to support larger models and provide more resources to the model to perform, then a higher G and lower CMP PRC-NPTN can be expected to work better. However, for compute constrained environments such as edge devices etc., a lower G and higher CMP would be more useful. It should be realized that the described method of choosing G and CMP are generalized heuristics. Some amount of hyperparameter optimization will nonetheless be needed to pick optimum values for any particular application and its related data. Thus, PRC-NPTNs do provide a new dimension along which networks can be further optimized to provide benefits that can adapt to each individual application. This was previously not possible with vanilla ConvNets and its derivative structures.

As would be realized by one of skill in the art, the methods described herein can be implemented by a system comprising a processor and memory, storing software that, when executed by the processor, performs the functions comprising the method. Also, as would be realized by one of skill in the art, other methods of determining which filters are to be pruned may be applied and are within the contemplated scope of the invention, which is specified by the claims which follow.

1. A method for reducing the complexity of a neural network using PRC-NPTN layers, the neural network having a hyperparameter G indicating a number of filters connected to each input channel and a hyperparameter CMP indicating a number of channel max pooling units, the method comprising:
training a PRC-NPTN network in accordance with a training protocol;
pruning the trained network to remove a subset of the filters in the network; and
fine-tuning the network by re-applying the training protocol.

2. The method of claim 1 wherein pruning the trained network comprises applying L1 pruning to the network.

3. The method of claim 2 wherein the filters are divided into a top segment which are retained in the network and a bottom segment which are removed from the network.

4. The method of claim 3 wherein a filter is placed in the into the bottom segment if the L1 norm of its activation response is in a lower percentage of the total number of filters.

5. The method of claim 4 wherein the percentage is controlled by a pruning parameter indicating a percentage of the total number of filters to be placed in the top segment and a percentage of the total number of filters which are to be placed in the bottom segment.

6. The method of claim 3 further comprising:
removing from the network or deactivating those filters which have been placed in the bottom segment.

7. The method of claim 5 wherein pruning the network further comprises:
iteratively reducing the pruning parameter and re-pruning the network such that a greater percentage of the filters are removed at each iteration until a desired trade-off between accuracy of the network and the number of remaining filters is reached.

8. The method of claim 5 wherein pruning the network further comprises:
iteratively applying the pruning parameter and re-pruning the network such that additional filters are removed at each iteration until a desired trade-off between accuracy of the network and the number of remaining filters is reached.

9. The method of claim 1 wherein G and CMP of the network are selected based on an application of the network and computing resources available to the network.

10. The method of claim 9 where in a higher G and a lower CMP are selected if computing-rich environments.

11. The method of claim 9 wherein a lower G and a higher CMP are selected for computing-constrained environments.

12. A system for reducing the complexity of a neural network using PRC-NPTN layers, the neural network having a hyperparameter G indicating a number of filters connected to each input channel and a hyperparameter CMP indicating a number of channel max pooling units, the system comprising:
a processor; and
memory, storing software that, when executed by the processor, performs the function of:
training a PRC-NPTN network in accordance with a training protocol;
pruning the trained network to remove a subset of the filters in the network; and
fine-tuning the network by re-applying the training protocol.

13. The system of claim 12 wherein pruning the trained network comprises applying L1 pruning to the network.

14. The system of claim 13 wherein the filters are divided into a top segment which are retained in the network and a bottom segment which are removed from the network.

15. The system of claim 14 wherein a filter is placed in the into the bottom segment if the L1 norm of its activation response is in a lower percentage of the total number of filters.

16. The system of claim 15 wherein the percentage is controlled by a pruning parameter indicating a percentage of the total number of filters to be placed in the top segment and a percentage of the total number of filters which are to be placed in the bottom segment.

17. The system of claim 14 wherein the software performs the further function of:
removing from the network or deactivating those filters which have been placed in the bottom segment.

18. The system of claim 16 wherein the software performs the further function of:
pruning the network by iteratively reducing the pruning parameter and re-pruning the network such that a greater percentage of the filters are removed at each iteration until a desired trade-off between accuracy of the network and the number of remaining filters is reached.

19. The system of claim 16 wherein the software performs the further function of:
pruning the network by iteratively applying the pruning parameter and re-pruning the network such that additional filters are removed at each iteration until a desired trade-off between accuracy of the network and the number of remaining filters is reached.
